(19) United States
(12) Patent Application Publication
(10) Pub. No.: US 2026/0187697 A1
(43) Pub. Date: Jul. 2, 2026

(54) Systems and Methods for Generating Product Recommendations Based on Hand Size

(71) Applicant: Lab153 Inc., Sheridan, WY (US)

(72) Inventors: Randall Marmet, Portland, ME (US); Andrew Reed, Greenwood, IN (US)

(21) Appl. No.: 19/438,710

(22) Filed: Jan. 2, 2026

Related U.S. Application Data
(60) Provisional application No. 63/741,205, filed on Jan. 2, 2025.

(51) Int. Cl. G06Q 30/0601; G06T 7/62

(52) U.S. Cl. CPC G06Q 30/0631; G06T 7/62; G06T 2207/20081; G06T 2207/30196

(57) ABSTRACT

A system and method for generating product recommendations based on hand size are disclosed. An image of a human hand is acquired using an image capture device and processed to identify anatomical landmark locations using image analysis. Physical hand dimensions are determined based on distances between selected landmark locations and are normalized to generate a standardized hand size value representing the hand relative to a reference population. The standardized hand size value is assigned to a hand size category based on threshold-based categorization. One or more product recommendations associated with the assigned hand size category are generated. The disclosed techniques enable objective hand size determination from image data and support consistent comparison and matching across users and products.

### CROSS-REFERENCE TO RELATED APPLICATIONS

This application claims the benefit of U.S. Provisional Application No. 63/741,205, filed Jan. 2, 2025, which is hereby incorporated by reference.

### BACKGROUND OF THE INVENTION

Products intended to be held, gripped, or otherwise manipulated by a user are often manufactured in a limited number of sizes or configurations. Proper fit between a user's hand and such products can affect comfort, usability, performance, and safety. In many contexts, users select products based on generalized size descriptors or subjective judgment rather than objective measurements of their own hand.

Existing approaches for determining hand size frequently rely on manual measurement techniques, static sizing charts, or self-reported information. Such approaches may be inconvenient, inaccurate, or difficult to apply consistently across different users. In addition, manual measurement techniques may require specialized tools or may be impractical in remote or mobile settings.

Thus, there is a need for systems and methods that can objectively determine hand size using readily available imaging devices and that can translate measured hand characteristics into standardized representations suitable for product selection or recommendation. There is further a need for techniques that enable consistent comparison of hand measurements across users and that support efficient matching between users and products.

### SUMMARY OF THE INVENTION

Disclosed are systems, methods, and computer-readable media for generating product recommendations based on hand size. An image of a human hand is captured using an image capture device and processed to identify a plurality of anatomical landmark locations of the hand using image analysis. Physical hand dimensions are determined based on distances between selected ones of the identified landmark locations.

The physical hand dimensions are normalized to generate a standardized hand size value that represents the user's hand relative to a reference population. The standardized hand size value is assigned to a hand size category based on threshold-based categorization. One or more product recommendations associated with the assigned hand size category are generated.

The disclosed techniques enable objective determination of hand size from image data and provide a standardized representation suitable for comparison across users and for matching users to products. The disclosed systems and methods may be implemented using one or more computing devices executing program instructions stored in non-transitory memory.

### BRIEF DESCRIPTION OF THE DRAWINGS

FIG. 1 illustrates an example workflow for capturing an image of a human hand, identifying hand features, determining physical hand dimensions, normalizing the measurements, categorizing hand size, and generating product recommendations.

FIG. 2 illustrates an example representation of a human hand with a plurality of predefined anatomical landmark locations identified thereon.

FIG. 3 illustrates determination of hand width and hand length based on distances between selected landmark locations on the hand.

FIG. 4 illustrates an example distribution of normalized hand size values across a population.

FIG. 5 illustrates an example image of a human hand captured by an image capture device, with a plurality of landmark locations overlaid thereon for illustrative purposes.

FIG. 6 illustrates an example image of a human hand captured together with a reference object having a known physical dimension for use in calibration of image-based hand measurements.

### DETAILED DESCRIPTION

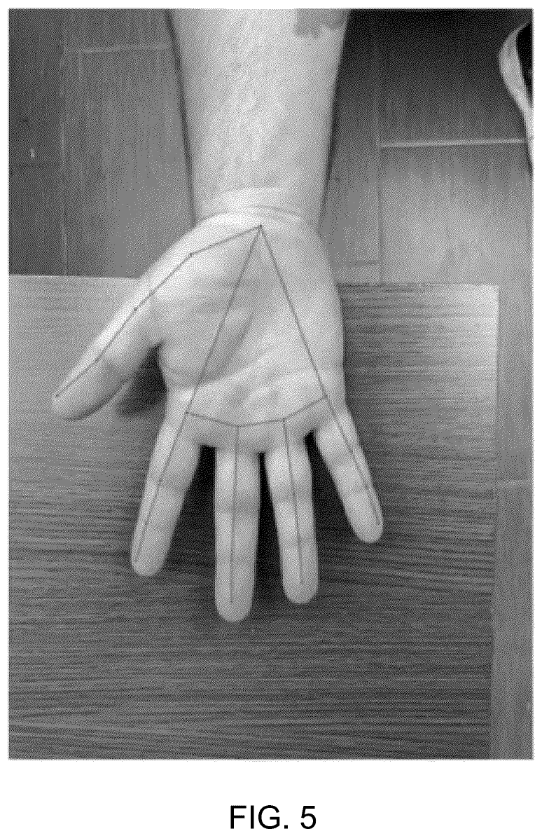

In one embodiment, the disclosed system evaluates hand fit by processing image data using artificial intelligence-based image analysis to identify anatomical features of a human hand and to derive physical measurements from those features. The system operates on images captured using an image capture device, such as a digital camera integrated into a mobile computing device, and converts visual information into structured numerical data that can be processed by one or more computing devices. An example image captured by such a device with detected anatomical landmark locations overlaid thereon is illustrated in FIG. 5.

When an image of a hand is captured, the system applies image processing techniques, including one or more trained artificial intelligence models, to analyze the image and to identify features corresponding to anatomical structures of the hand. Rather than relying on subjective user input or heuristic estimation, the system uses computational analysis of the image to locate and characterize specific portions of the hand in a repeatable manner. The output of this analysis is not merely a classification or label, but a set of machine-usable representations that form the basis for subsequent measurement operations.

In an alternative implementation of the image capture device described above, the image capture device comprises a depth-sensing device configured to capture depth information corresponding to the surface of the human hand. The depth-sensing device may include a light detection and ranging (LiDAR) sensor or another depth-measurement system capable of generating a depth map or three-dimensional representation of the hand. In such implementations, anatomical landmark locations may be identified directly from the depth information, and physical hand dimensions may be determined based on spatial distances within the three-dimensional representation. In some implementations, the use of depth information reduces or eliminates reliance on a separate reference object for calibration.

The image captured by the image capture device is represented internally as machine-readable image data. From the perspective of the processing system, the image comprises numerical values arranged according to the geometry of the imaging sensor. These numerical values provide the raw input from which the artificial intelligence-based analysis identifies hand features. While the underlying image data is expressed in terms of pixel values associated with spatial locations within the image, the system's operation is not limited to pixel-level interpretation. Instead, the system leverages learned models to infer higher-level anatomical structure from the image data.

The apparent size and orientation of the hand within the captured image may vary depending on the image capture device and capture conditions, including camera resolution, distance between the hand and the camera, and lighting environment. The system does not assume a fixed capture configuration. Instead, it is designed to extract anatomical information from the image in a manner that is robust to such variation, and to later convert image-derived measurements into physical measurements using calibration techniques described below.

Prior to or during application of the artificial intelligence-based analysis, the system may perform preprocessing operations on the image data to facilitate reliable feature detection. Such preprocessing may include adjusting image orientation, isolating a region of interest containing the hand, or normalizing image characteristics to reduce the effects of lighting variation. These operations are performed on the machine-readable image data and are selected to support consistent identification of anatomical features across different capture conditions.

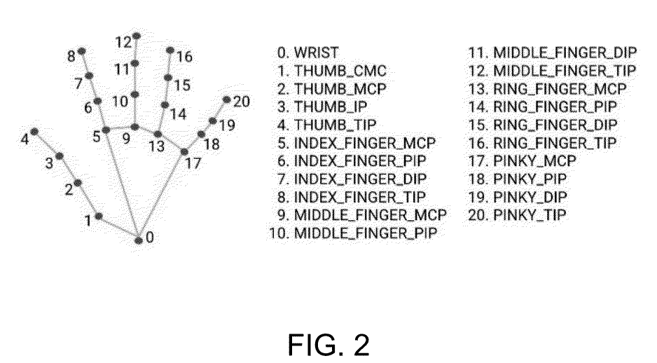

Once the image data has been analyzed, the system identifies a predefined set of anatomical landmarks of the hand. FIG. 2 illustrates an example representation of a human hand with a plurality of predefined anatomical landmark locations identified thereon. The landmark set corresponds to physical structures of the hand, including a wrist location and joint locations along each finger. The landmarks are selected to provide a consistent anatomical reference framework across different users and different image captures. In one embodiment, the landmark set includes multiple joints along each finger as well as fingertip locations, enabling detailed characterization of hand geometry.

In some implementations, landmark identification is performed using a machine learning model that has been trained to detect predefined anatomical features of the human hand from an image.

The artificial intelligence-based analysis produces, for each identified landmark, a corresponding numerical representation indicating the location of that landmark within the image. These representations may take the form of coordinate values associated with positions in the image data. The coordinates provide a structured description of the hand's anatomy as observed in the image and serve as inputs to subsequent measurement computations.

The landmark coordinates are expressed relative to the image data from which they are derived. As such, distances between landmarks are initially expressed in image-based units corresponding to the spatial representation of the image. At this stage, the coordinates capture the relative geometry of the hand as it appears in the image, independent of absolute physical scale. This representation allows the system to compute distances, angles, and relationships between anatomical features in a consistent and computationally efficient manner.

In some embodiments, the system applies additional processing to the landmark data to improve stability and reliability. For example, when multiple images or image frames are analyzed, landmark coordinates may be aggregated, filtered, or averaged to reduce variation resulting from noise, motion, or transient capture artifacts.

By representing the hand as a set of anatomically meaningful landmarks with associated numerical coordinates, the system establishes a structured intermediate representation that bridges artificial intelligence-based image analysis and physical measurement. Subsequent processing stages operate on this landmark-based representation to convert image-derived geometry into calibrated physical dimensions, as described in further detail below.

Once the hand has been represented as a set of anatomically meaningful landmarks with associated numerical coordinates, the system addresses the fact that distances between those landmarks are initially expressed in image-based units rather than physical units. The same physical hand may produce different numerical distances between landmarks depending on factors such as camera resolution, distance from the camera, and optical characteristics of the image capture device. As a result, landmark coordinates derived directly from image data do not, by themselves, provide reliable physical measurements of the hand.

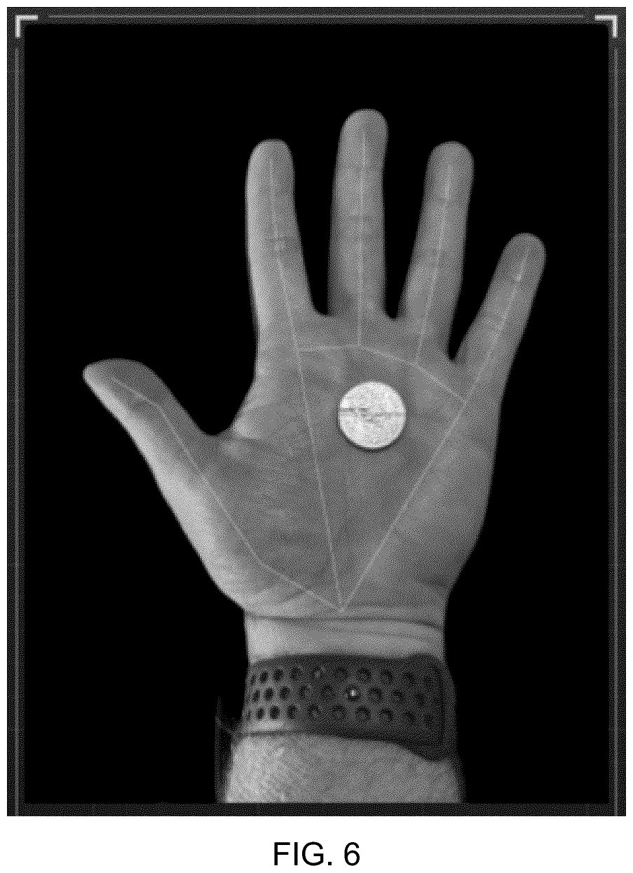

To convert image-based measurements into physical measurements, the system uses a reference object having a known physical dimension that is present within the captured image, as shown in FIG. 6 and described in greater detail below. In one embodiment, the reference object is a coin having a standardized diameter, such as a U.S. quarter. The reference object is positioned within the field of view of the image capture device at the time the image of the hand is captured, such that the reference object and the hand appear in the same image.

The system applies image analysis techniques to identify the reference object within the image data. Identification of the reference object may be performed using shape recognition, size characteristics, or other visual features associated with the reference object. Once identified, the system determines a numerical measurement corresponding to the reference object as it appears in the image. This numerical measurement is derived from the same image-based coordinate space used to represent the hand landmarks.

Because the physical dimension of the reference object is known in advance, the system computes a scale factor that relates image-based units to physical units. The scale factor is determined based on a comparison between the known physical dimension of the reference object and the numerical measurement of the reference object derived from the image. This scale factor provides a mapping between distances expressed in the image coordinate space and corresponding distances expressed in physical units.

The system applies the computed scale factor to distances between hand landmarks to convert those distances into physical measurements. For example, a distance between two landmark coordinates expressed in image-based units may be multiplied by the scale factor to yield a corresponding physical distance. In this manner, the system derives physical measurements of the hand from image-derived landmark data without requiring specialized depth sensors or pre-calibrated camera hardware.

The use of a reference object enables the system to perform physical measurement in a manner that is robust to variation in image capture conditions. Because the scale factor is derived from the same image as the hand landmarks, differences in camera resolution, distance between the hand and the camera, or image cropping are inherently accounted for. As a result, the system can generate consistent physical measurements across different devices and capture environments.

In some embodiments, the system may verify the suitability of the reference object for calibration. For example, if the reference object is partially occluded or insufficiently resolved within the image, the system may determine that calibration cannot be reliably performed and may prompt the user to recapture the image.

In some embodiments, the system may support alternative reference objects having known physical dimensions. The reference object need not be limited to a specific form, provided that its physical dimension is known and can be reliably identified within the image. In some embodiments, multiple reference objects may be detected within a single image, and the system may select one or more of the detected reference objects for calibration.

By calibrating image-derived landmark distances using a reference object present within the image, the system establishes a reliable conversion between image-based measurements and physical measurements. This calibrated representation enables subsequent computation of hand dimensions that correspond to real-world physical characteristics of the user's hand.

Using the calibrated landmark representation, the system computes one or more physical dimensions of the hand that characterize real-world aspects of the user's hand. These dimensions are selected to capture geometric characteristics of the hand that are relevant to interaction with a physical object, such as gripping, reaching, or maintaining control during use.

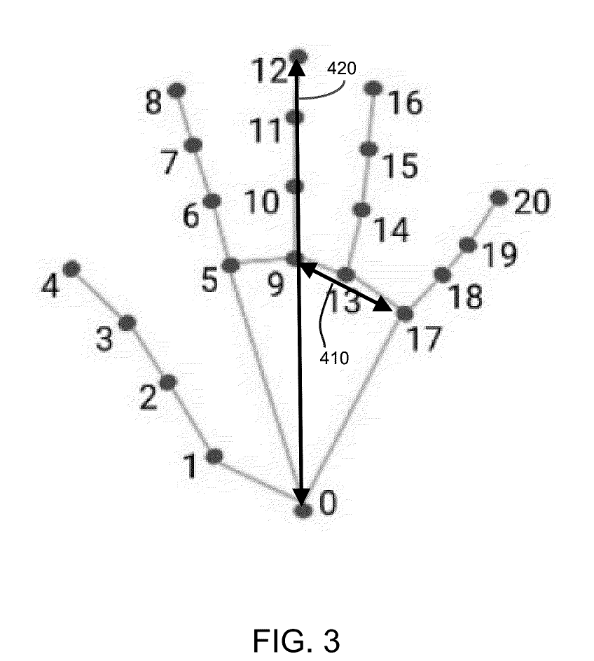

In one embodiment, the system computes a hand width based on a distance between two landmarks positioned on opposing sides of the hand. The selected landmarks correspond to anatomical locations that approximate the lateral extent of the hand when the fingers are in a natural, relaxed position, as illustrated in FIG. 3. The distance between these landmarks, expressed in physical units following calibration, provides a quantitative representation of hand width. In some embodiments, the hand width measurement is further adjusted to represent the effective width of a subset of fingers that engage a product grip, rather than the maximum span of the hand.

In addition to hand width, the system computes a hand length based on a distance between a landmark corresponding to a wrist location and a landmark corresponding to a fingertip location, as shown in FIG. 3. This distance represents an approximate longitudinal dimension of the hand. In some embodiments, the hand length measurement is adjusted to account for soft tissue beyond the fingertip landmark or for variations in how different users contact an object during use.

The system may compute additional dimensional measurements derived from the calibrated landmark coordinates. Such measurements may include distances between intermediate finger joints, relative proportions between different segments of the hand, or composite measures derived from multiple landmark distances. These additional measurements provide further characterization of hand geometry and may be used to refine assessment of hand fit for particular products or use scenarios.

In some embodiments, the system applies weighting to different hand dimensions when evaluating hand fit. For example, dimensions related to grip width may be weighted more heavily than dimensions related to reach, reflecting the relative importance of those dimensions for secure and comfortable interaction with a product. The weighting applied to different dimensions may be fixed or configurable and may be selected based on empirical evaluation, ergonomic considerations, or observed usage patterns. The use of weighted dimensional measures allows the system to emphasize aspects of hand geometry that are most relevant to a particular application without discarding other dimensional information.

The hand dimensions computed by the system are derived directly from calibrated physical measurements and are therefore independent of the particular image capture device used to acquire the image. Because the dimensions are computed from landmark coordinates that have been converted into physical units, the resulting measurements correspond to real-world characteristics of the user's hand rather than image-specific representations.

In some embodiments, the system derives a standardized numerical representation of a user's hand based on multiple computed hand dimensions. Rather than treating each physical dimension independently, the system combines selected dimensional measurements to produce a consolidated representation of hand size or hand geometry that can be compared consistently across different users and against stored product dimensions. This consolidated representation reduces variability arising from individual measurement differences and provides a common basis for subsequent normalization, categorization, and product matching operations.

By computing hand dimensions from calibrated landmark data in this manner, the system produces a physically meaningful representation of the hand that can be used consistently across different devices, capture conditions, and usage environments. This representation forms a foundation for subsequent normalization, indexing, and comparison operations performed by the system. In one illustrative example, the system determines a distance between landmark target points 0 and 12 corresponding to a wrist location and a fingertip location (420 of FIG. 3). The measured distance is multiplied by a proportional scaling factor to obtain an effective hand length value. For example, if the distance between target points 0 and 12 is measured as 7.0 inches, the system computes an effective hand length value of 7.0×1.08=7.56 inches. This example illustrates one manner in which effective hand length may be derived from calibrated landmark measurements.

In another illustrative example, the system determines a distance between landmark target points 9 and 17 corresponding to opposing sides of the hand (410 of FIG. 3). The measured distance between these target points is divided by three and multiplied by four to obtain a derived three-finger width value. The derived three-finger width value is then multiplied by an additional scaling factor to obtain an overall hand width value that reflects functional grip engagement. These operations are performed using the calibrated landmark coordinates such that the resulting values are expressed in physical units.

By way of example, if the distance between target points 9 and 17 is measured as 2.25 inches, the system computes a derived three-finger width value of (2.25÷3)×4=3.0 inches, and an overall hand width value of 3.0×1.5=4.5 inches. This example illustrates one manner in which a functional hand width may be derived from calibrated landmark measurements. Other distances, proportional relationships, and scaling factors may be used depending on the intended application.

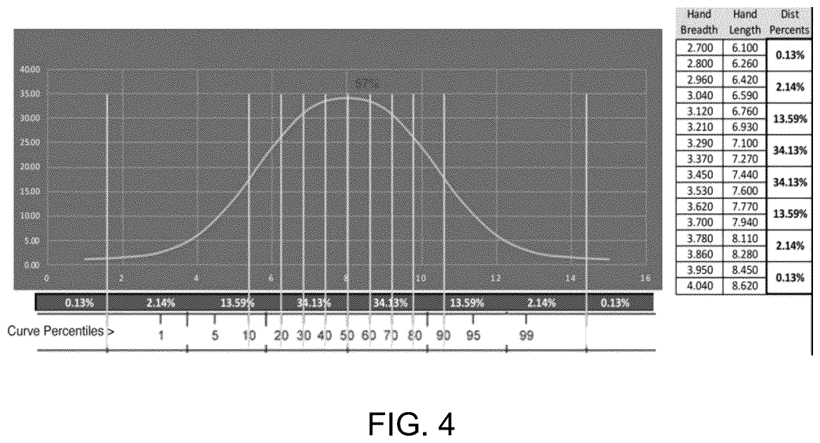

After physical hand dimensions have been computed from calibrated landmark data, the system further processes the physical measurements to produce a standardized representation of the hand that facilitates comparison across users and enables efficient matching to stored product categories. In one embodiment, the system transforms one or more physical hand measurements into a normalized hand size value or index that represents the user's hand relative to a reference population, as illustrated in FIG. 4.

The system may combine the derived hand width value and the derived hand length value to form a consolidated representation of hand size. In some embodiments, the combination reflects that certain dimensions, such as grip-related hand width, are more determinative of fit for a given product than other dimensions, such as hand length. The consolidation may therefore involve applying proportional adjustments or weighting factors to one or more derived values prior to combination, without requiring that all dimensions contribute equally.

Once a consolidated hand size representation has been computed, the system normalizes the consolidated value to a standardized scale to enable comparison across users, as illustrated in FIG. 4. In one embodiment, the system maps the consolidated hand size representation to a bounded numerical range, such as a scale from 0 to 100, in which a position on the scale represents a relative size of the user's hand within a reference population.

The bounded numerical scale defines a finite range of possible normalized values within which hand size representations are constrained for purposes of comparison and categorization.

In one embodiment, the normalized hand size value represents a relative position of the user's hand within the reference population. For example, a normalized value on a standardized scale may indicate a percentile position of the user's hand size relative to other users, such that a value of approximately 57 on a 0-100 scale indicates that the user's hand size is larger than approximately fifty-seven percent of hands in the reference population, as illustrated in FIG. 4. In another embodiment, the normalized value is assigned based on predetermined ranges or thresholds corresponding to segments of the population, such as segments representing ten-percent bands of the population, even though the physical size range represented by each band may vary across the distribution.

When standardized hand size values are observed across a population of users, the resulting values may be understood to form a non-uniform distribution in which a greater number of users fall within intermediate ranges and fewer users fall at extreme ranges. For example, when plotted, the distribution of normalized hand size values may resemble a bell-shaped curve. In such a distribution, equal population segments may correspond to unequal physical measurement ranges, such that smaller differences in physical hand dimensions may separate users near the center of the distribution while larger differences may separate users near the extremes. This observation motivates the use of non-uniform threshold ranges and segmented categories when mapping normalized hand size values to standardized scales or buckets. Other distributions, normalization schemes, or segmentation approaches may be used, and the invention is not limited to any particular statistical model.

The system may further assign the normalized hand size value to a discrete category or bucket based on the standardized scale. For example, a standardized scale may be divided into a plurality of value ranges, and the user's hand may be assigned to a category corresponding to the range in which the normalized value falls. These categories may be used to simplify matching between the user's hand and stored product groupings during subsequent recommendation operations.

In one embodiment, the normalization and categorization operations are implemented by executing program instructions stored in non-transitory memory on a processing system. The program instructions may implement conditional logic, threshold comparisons, or lookup operations that map derived hand dimensions or consolidated hand size representations to standardized values or discrete categories. Such operations may be performed by one or more computing devices, including a backend server or other processing system configured to support hand size evaluation and product recommendation.

The standardized hand size value and any associated category assignment may be stored in association with a user profile and used to drive subsequent selection, ranking, or recommendation operations. By normalizing hand measurements into a standardized representation, the system reduces the complexity of matching operations and enables efficient comparison between different users and between users and stored product specifications.

In some embodiments, the standardized hand size value and associated derived hand dimensions are further processed using threshold-based logic to assign discrete category values that facilitate matching and recommendation. The threshold-based logic maps continuous hand dimension values into predefined ranges, each range corresponding to a standardized category value.

In one example implementation, a derived hand length value expressed in physical units is evaluated against a sequence of increasing threshold values, and a corresponding category value is assigned based on the range in which the derived hand length falls. In this example, the standardized category values are selected from a bounded set including values of 10, 20, 30, 40, 50, 60, 70, 80, 90, and 100.

By way of illustration, hand length values less than or equal to 6.6 inches are assigned a category value of 10, hand length values less than or equal to 6.9 inches are assigned a category value of 20, hand length values less than or equal to 7.1 inches are assigned a category value of 30, hand length values less than or equal to 7.3 inches are assigned a category value of 40, hand length values less than or equal to 7.5 inches are assigned a category value of 50, hand length values less than or equal to 7.7 inches are assigned a category value of 60, hand length values less than or equal to 7.9 inches are assigned a category value of 70, hand length values less than or equal to 8.1 inches are assigned a category value of 80, hand length values less than or equal to 8.4 inches are assigned a category value of 90, and hand length values less than or equal to 9.9 inches are assigned a category value of 100. Hand length values falling outside the defined range may be identified as invalid or out-of-range values.

In a similar manner, a derived hand width value expressed in physical units may be evaluated against a sequence of width-specific threshold values to assign a corresponding width category. In one example implementation, hand width values less than or equal to 2.94 inches are assigned a category value of 10, hand width values less than or equal to 3.09 inches are assigned a category value of 20, hand width values less than or equal to 3.2 inches are assigned a category value of 30, hand width values less than or equal to 3.3 inches are assigned a category value of 40, hand width values less than or equal to 3.4 inches are assigned a category value of 50, hand width values less than or equal to 3.52 inches are assigned a category value of 60, hand width values less than or equal to 3.61 inches are assigned a category value of 70, hand width values less than or equal to 3.71 inches are assigned a category value of 80, hand width values less than or equal to 3.86 inches are assigned a category value of 90, and hand width values less than or equal to 5.5 inches are assigned a category value of 100. Hand width values falling outside the defined range may likewise be identified as invalid or out-of-range values.

The threshold-based categorization logic may be implemented using conditional evaluation performed by a processing system. In one embodiment, the logic evaluates the derived hand dimension against the threshold values in sequence and assigns the first category value whose associated condition is satisfied. Equivalent logic may be implemented using nested conditional statements, lookup tables, decision trees, or other rule-based structures executed by program instructions stored in non-transitory memory.

In some embodiments, the category values assigned to derived hand width and derived hand length are further combined to produce a consolidated standardized value or index representing overall hand fit. The combination may reflect that certain dimensions, such as hand width, are more determinative of fit than other dimensions, such as hand length, depending on the intended interaction with a product. In some implementations, the consolidated value is selected such that the more restrictive of the width-based or length-based category values governs the final assignment, while in other implementations proportional adjustments or priority rules are applied.

Once determined, the standardized category value or consolidated index may be used to select, rank, or filter products associated with corresponding size categories. For example, products may be grouped according to category values corresponding to ranges of hand size, and the system may identify and present products associated with the category assigned to the user's hand. In some embodiments, adjacent categories may also be considered to account for user preference or tolerance.

Although specific threshold values and category assignments are shown for purposes of illustration, other threshold values, category ranges, and mapping schemes may be used to accommodate different user populations, product types, or desired classification granularity. In practice, the threshold values may be adjusted, reordered, or replaced to accommodate different user populations, product types, or empirical calibration data without departing from the disclosed techniques.

The standardized hand size value, category assignment, or consolidated index associated with a user is used to identify products that are compatible with the user's hand size. To support such matching, products are represented within the system using corresponding size-related attributes that are comparable to the standardized hand representation.

Each product is associated with one or more size attributes that characterize how the product is intended to be handled by a user. The size attributes are derived from physical dimensions of the product, design specifications, manufacturer data, empirical evaluation, or combinations thereof. The product size attributes are normalized or categorized using the same standardized scale or category structure used for the user's hand, such that both the user and the product are represented within a common comparison space.

Products are assigned to one or more size categories corresponding to ranges of hand size values for which the product is suitable. For example, a product is associated with a category value or a range of category values indicating that the product is designed for users whose standardized hand size falls within that range. Product category assignments are stored in a database or other data structure accessible to the processing system.

Once a standardized hand size value or category has been determined for a user, the system compares the user's standardized representation to the product representations to identify compatible products. In some implementations, products whose assigned category matches the user's category are selected. In other implementations, products whose assigned category falls within a defined tolerance range relative to the user's category, such as adjacent categories above or below the user's assigned category, are also considered.

Compatible products are ranked based on the degree of correspondence between the user's standardized hand representation and the product representation. Products whose assigned category more closely matches the user's category are ranked higher than products associated with more distant categories. Additional factors, such as user preferences, availability, or usage context, are applied to refine the ranking or ordering of results.

The matching and ranking operations are performed programmatically by executing instructions stored in non-transitory memory on a processing system. The system retrieves product records from a data store, compares stored product category values to the user's standardized hand category, and generates a ranked or filtered set of products based on predefined matching rules.

The system generates a set of recommendations based on the matching results and presents the recommendations to the user. The recommendations include product identifiers, descriptive information, or other data suitable for display. Products falling outside a defined compatibility range are excluded from the recommendations or identified as less suitable.

In some implementations, product matching parameters are updated over time. For example, feedback derived from user interactions, such as selection behavior or usage outcomes, is used to refine product category assignments, tolerance ranges, or ranking rules without requiring changes to the underlying hand measurement or normalization processes.

By representing both user hand size and product size attributes within a common standardized framework and applying rule-based matching logic, the system provides a practical mechanism for selecting, ranking, and recommending products based on physical compatibility between a user and a product. The matching and recommendation operations constitute a concrete application of the measured and standardized hand data and result in actionable outputs produced by the system.

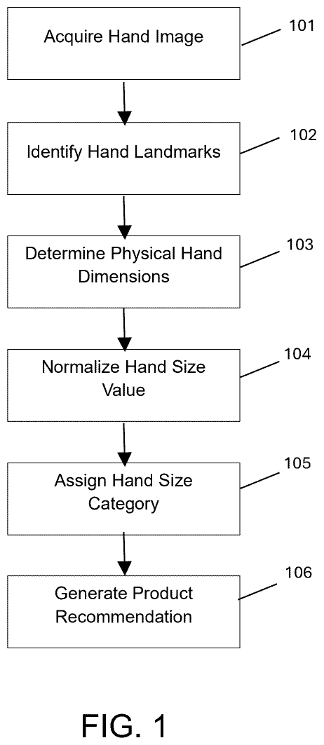

Turning now to FIG. 1, a workflow for generating product recommendations based on hand size is illustrated.

At step 101, an image of a human hand is acquired using an image capture device. The image may be captured using a camera integrated into a mobile computing device and may include the hand positioned within a field of view of the image capture device.

At step 102, a plurality of landmark locations on the human hand are identified from the image using image analysis. The identified landmark locations correspond to predefined anatomical features of the hand and are represented as numerical values associated with positions in the image.

At step 103, physical hand dimensions are determined based on distances between selected ones of the identified landmark locations. As part of this step, the system may convert image-based distances into physical measurements using a reference object present in the image and may compute one or more hand dimensions, such as hand width or hand length, from the calibrated landmark data.

At step 104, the physical hand dimensions are normalized to generate a standardized hand size value representing the human hand relative to a reference population. The normalization may include mapping the physical hand dimensions to a bounded numerical scale or index.

At step 105, the standardized hand size value is assigned to a hand size category based on threshold-based categorization. The hand size category may correspond to a segment of a standardized scale used to group users with similar hand sizes.

At step 106, a recommendation identifying one or more products associated with the assigned hand size category is generated. The recommendation may be presented to the user or used to drive subsequent selection, ranking, or matching operations.

The operations described herein may be implemented by one or more computing devices executing program instructions stored in non-transitory memory. The computing devices may include one or more processors configured to process image data, perform measurement computations, normalize values, and generate recommendations as described above.

The disclosed functionality may be implemented in hardware, software, firmware, or combinations thereof, and may be executed on a single computing device or distributed across multiple computing devices in communication with one another.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A system for generating product recommendations based on hand size, comprising:
an image capture device configured to acquire an image of a human hand; and
a processing system operatively coupled to the image capture device, the processing system configured to
receive the image of the human hand;
identify a plurality of landmark locations on the human hand from the image using image analysis;
determine physical hand dimensions based on distances between selected ones of the identified landmark locations;
normalize the physical hand dimensions to generate a standardized hand size value representing the human hand relative to a population;
assign the standardized hand size value to a hand size category based on threshold-based categorization; and
generate a recommendation identifying one or more products associated with the assigned hand size category.

2. The system of claim 1 wherein identifying the plurality of landmark locations comprises applying a machine learning model that has been trained to detect predefined anatomical features of the human hand from the image.

3. The system of claim 2 wherein the predefined anatomical features correspond to joints, fingertips, and a wrist region of the human hand.

4. The system of claim 1 wherein determining the physical hand dimensions comprises determining a hand width based on a distance between opposing landmark locations on lateral portions of the human hand.

5. The system of claim 1 wherein determining the physical hand dimensions comprises determining a hand length based on a distance between a landmark location corresponding to a wrist region and a landmark location corresponding to a fingertip.

6. The system of claim 1 wherein the physical hand dimensions are determined using a calibration reference having a known physical dimension present within the image.

7. The system of claim 1 wherein normalizing the physical hand dimensions comprises mapping the physical hand dimensions to a bounded numerical scale representing relative hand size within a population.

8. The system of claim 7 wherein the bounded numerical scale is segmented into non-uniform ranges selected based on a distribution of hand sizes across the population.

9. The system of claim 1 wherein assigning the standardized hand size value to the hand size category comprises comparing the standardized hand size value to a plurality of predefined threshold values.

10. The system of claim 1 wherein generating the recommendation comprises identifying products whose associated size category matches the assigned hand size category.

11. The system of claim 10 wherein generating the recommendation further comprises identifying products associated with size categories adjacent to the assigned hand size category.

12. The system of claim 1 wherein generating the recommendation comprises ranking a plurality of products based on a degree of correspondence between the assigned hand size category and product size categories.

13. The system of claim 1 wherein the standardized hand size value is stored in association with a user profile.

14. The system of claim 1 wherein the image capture device comprises a depth-sensing device configured to generate three-dimensional spatial data corresponding to a surface of the human hand.

15. A method for generating product recommendations based on hand size, comprising:
(a) acquiring an image of a human hand using an image capture device;
(b) identifying a plurality of landmark locations on the human hand from the image using image analysis;
(c) determining physical hand dimensions based on distances between selected ones of the identified landmark locations;
(d) normalizing the physical hand dimensions to generate a standardized hand size value representing the human hand relative to a population;
(e) assigning the standardized hand size value to a hand size category based on threshold-based categorization; and
(f) generating a recommendation identifying one or more products associated with the assigned hand size category.

16. The method of claim 15 wherein identifying the plurality of landmark locations comprises applying a machine learning model that has been trained to detect predefined anatomical features of the human hand from the image.

17. The method of claim 15 wherein determining the physical hand dimensions comprises determining a hand width based on a distance between opposing landmark locations on lateral portions of the human hand and determining a hand length based on a distance between a landmark location corresponding to a wrist region and a landmark location corresponding to a fingertip.

18. The method of claim 15 wherein normalizing the physical hand dimensions comprises mapping the physical hand dimensions to a bounded numerical scale representing relative hand size within a population and segmenting the bounded numerical scale into non-uniform ranges.

19. The method of claim 15 wherein generating the recommendation comprises identifying products associated with size categories adjacent to the assigned hand size category and ranking the identified products based on a degree of correspondence to the standardized hand size value.

20. A non-transitory computer-readable medium comprising instructions that, when executed by one or more processors, cause the one or more processors to perform operations comprising:
(a) receiving an image of a human hand;
(b) identifying a plurality of landmark locations on the human hand from the image using image analysis;
(c) determining physical hand dimensions based on distances between selected ones of the identified landmark locations;
(d) normalizing the physical hand dimensions to generate a standardized hand size value representing the human hand relative to a population;
(e) assigning the standardized hand size value to a hand size category based on threshold-based categorization; and
(f) generating a recommendation identifying one or more products associated with the assigned hand size category.

21. The non-transitory computer-readable medium of claim 20 wherein the instructions, when executed by the one or more processors, further cause the one or more processors to identify products associated with size categories adjacent to the assigned hand size category and rank the identified products based on a degree of correspondence to the standardized hand size value.
